(19) United States
(12) Patent Application Publication
(10) Pub. No.: US 2004/0205306 A1
(43) Pub. Date: Oct. 14, 2004

(54) Manipulating data for improving storage and transmission

(76) Inventors: David Janas, El Dorado Hills, CA (US); Geoffrey A. Gould, El Dorado Hills, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/409,484

(22) Filed: Apr. 8, 2003

(51) Int. Cl. G06F 12/00

(52) U.S. Cl. 711/154

(57) ABSTRACT

In one embodiment of the present invention, a method includes manipulating a first data image into a modified data image, where the modified data image has a faster write time than the first data image for a memory. The manipulation may be based on an algorithm selected on a priori knowledge of at least one characteristic of the memory or transmission channel to which the modified data is to be sent.

### BACKGROUND

Flash memory is a high-speed electrically erasable programmable read-only memory (EEPROM) in which erasing and programming (i.e., writing) is performed on blocks of data. There are several different kinds of flash memory, including NOR-based and NAND-based memories. NOR flash devices typically have longer erase speeds than NAND flash devices. NAND flash devices are typically an order of magnitude faster or more than NOR flash devices for erase and program operations.

Flash memory conventions define a logical or binary one as few, if any, electrons stored on a floating gate of a memory cell. A logical or binary zero is defined as many electrons stored on the floating gate. Erasure of a flash memory causes a logical one to be stored in each bit cell. Writing a binary zero into a NOR flash memory array requires some time and energy because, by convention, writing zero applies voltage pulses to the NOR flash transistor to trap electrons on its floating gate to increase its threshold voltage. Writing a binary one into a NOR flash memory array requires zero time and zero energy because, by convention, the memory array is already full of “1” data after a prior erase operation which removed electrons from the floating gates and decreased the threshold voltages.

Users desire faster writing speed (i.e., programming speed), and lower energy consumption, particularly where memories are used in wireless or other battery-operated devices. Current flash memories often have undesirably slow writing speeds and use significant energy in performing such write operations. Similarly, transmission of data requires a certain amount of energy. For users of battery-operated devices, significant transmissions can adversely affect battery lifetime. Thus a need exists for techniques to improve write speed and reduce power consumption.

### BRIEF DESCRIPTION OF THE DRAWINGS

FIG. 1 is a flow diagram of a method in accordance with one embodiment of the present invention.

FIG. 2 is a block diagram of data images in accordance with one embodiment of the present invention.

FIG. 3 is a block diagram of a wireless device with which an embodiment of the present invention may be used.

### DETAILED DESCRIPTION

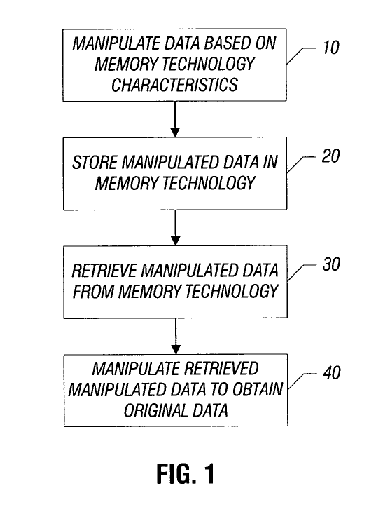

Referring now to FIG. 1, shown is a flow diagram of a method in accordance with one embodiment of the present invention. As shown in FIG. 1, data may be manipulated based on characteristics of the memory technology to be used (block 10). After manipulation, the manipulated data may be stored in the memory technology (block 20). Next, as desired the manipulated data may be retrieved from the memory technology (block 30). Then, the retrieved manipulated data may be manipulated to obtain the original data (block 40). Such data may be then used for data processing purposes, performance of code instructions, or transmission to a desired location, for example.

In various embodiments, an algorithm such as a mathematical algorithm may be used to manipulate a data image such as code, data, or other information to be stored. Such manipulation may increase speed (measured, for example, in kilobytes (KB) per second) and may further reduce energy consumption (measured, for example, in Joules/byte) required to store the data in a memory technology, when that memory technology requires different amounts of time and energy to write one binary digit (for example, “0”) than the other binary digit (for example, “1”). While the memory technology may vary, in one embodiment a flash memory, and more specifically a NOR flash memory may be the target memory technology. In another embodiment, a silicon-oxide-nitride-oxide-silicon (SONOS) memory may the target memory technology. In yet other embodiments, an optical memory technology such as compact disk (CD)-based storage may used. Other embodiments may be used in phase-change or ferroelectric memory technologies, for example.

In addition to speed and energy requirements for different binary digits, other features of a data set, such as second order complexity of programming speeds, may provide for improved speed and energy consumption. For example, in certain memory technologies, a pair of zeros side-by-side are faster to write than a pair of zeros having a one interspersed between them. In such a technology, an algorithm may be used to bias a manipulated data image to group zeros together.

In other embodiments, other features of a memory technology may be leveraged to reduce writing time and/or energy requirements. For example, certain memory technologies have faster speeds in programming zeros on a wordline, or for a given byte to have a particular number of zeros (e.g., four zeros in a byte). Various algorithms may be implemented to bias a modified data image for such characteristics.

For many transmission technologies, energy consumed in transmitting data may be caused by changes in values (e.g., represented by different voltages) between different data points. Thus in such technologies, a data image may be modified to reduce variability between bits. In other words, the modified data image may have substantially continuous portions of identical values (e.g., portions of all ones followed by portions of all zeros).

Thus data manipulation in accordance with various embodiments of the present invention may be performed to optimize a modified data image for a particular memory or transmission technology based on a priori knowledge of certain characteristics of the technology. As such, various algorithms may be implemented to modify a data image to take advantage of different characteristics of the target technology. In certain embodiments, a look up table may be formed and used to create modified data images optimized for write speed and/or energy requirements (among other characteristics) of a given target technology.

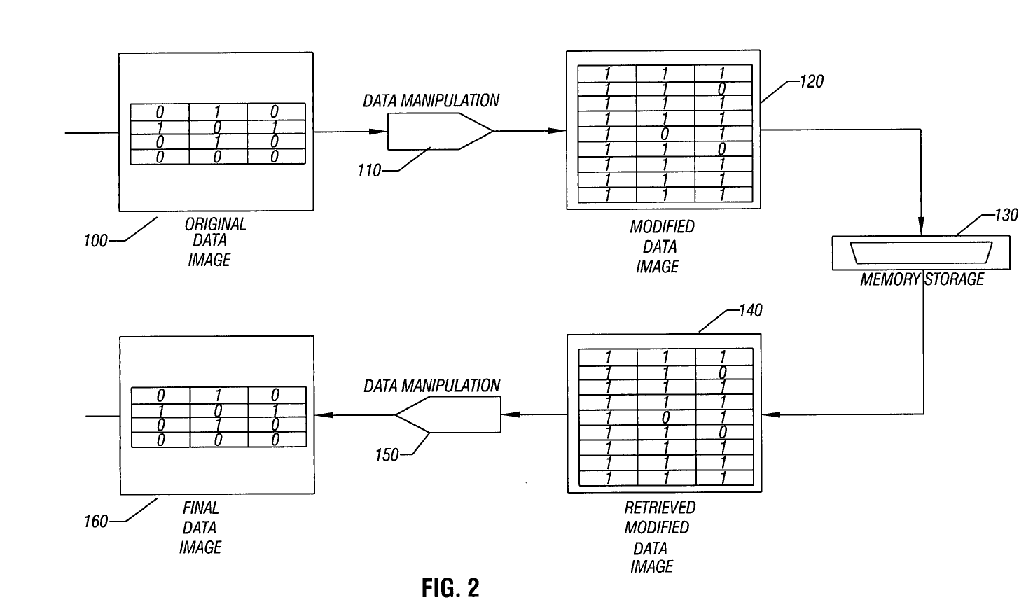

Referring now to FIG. 2, shown is a block diagram of data images in accordance with an embodiment of the present invention. As shown in FIG. 2, an original data image 100 includes a memory array having three columns and four rows. As shown, original data image 100 includes more zeros than ones. Original data image 100 may be manipulated in accordance with an embodiment of the present invention (block 110) to obtain a modified data image 120. As shown in FIG. 2, modified data image 120 is larger than original data image 100. More specifically in the embodiment of FIG. 2, modified data image 120 includes a memory array having three columns and nine rows. Also, modified data image 120 includes a substantial number of ones. More specifically, virtually all data in the array is comprised of ones. Of course, the relative concentration of ones to zeros may vary in different embodiments.

FIG. 2 also shows the storage of modified data image in storage device 130 which, in one embodiment may be a NOR flash memory. As desired, modified data image 140 may be retrieved from storage device 130. As shown in FIG. 2, in one embodiment retrieved modified data image 140 may be identical to modified data image 120. Then, data manipulation may be performed (block 150) on the retrieved modified data image 140 and a final data image 160 may be obtained which is identical to original data image 100.

As shown in FIG. 2, in certain embodiments such data manipulation may be performed before writing the original data image into the memory, and the manipulated data image may be stored instead. Subsequently, a reverse manipulation may be used to recreate the exact original data image from the manipulated data image retrieved from the memory, in certain embodiments. In some embodiments, the manipulated data image may be larger than the original data image, but may have faster write speed (and/or lower energy consumption) because the manipulated data image may be biased to minimize the occurrence of the slower (and/or less energy-demanding) binary digit (for example, “0”) or the slower (and/or less energy-demanding) elements of the data set. While such embodiments may increase bit size of the stored data image, reduced storage or transmission time (measured, for example, in microseconds/byte) and energy of storage or transmission may be accomplished. Such transmission may include, for example, data transmission over wired or wireless channels (and may include data transmitted using various modulation schemes). While in certain embodiments, the modified data image may be larger than the original data image, in many embodiments the modified data image may be smaller than the original image, particularly if the data manipulation is combined with a lossless data compression technique.

In another embodiment, a different manipulation algorithm (and complementary reverse-manipulation algorithm) may be used to store and retrieve data with acceptable but imperfect accuracy. Such accuracy may be sufficient for lossy codecs or other coding devices.

In certain embodiments, data manipulation may be applied independently of, or in conjunction with, existing data compression algorithms or modulation techniques. For example, algorithms in accordance with the present invention may be used in connection with Lempel-Ziv (LZ) compression, Moving Picture Experts Group (MPEG) II, coded orthogonal frequency division multiplexing (COFDM), and the like.

Data manipulation in accordance with embodiments of the present invention (including both the first manipulation and later reverse manipulation) may be implemented in a variety of locations within or external to a storage system. For example, manipulation logic may be implemented in logic circuits embedded inside a monolithic semiconductor memory device, or a software algorithm executed by a controller stacked with the memory technology inside a multi-chip memory subsystem package. Alternately, a software algorithm may be executed by an external processor separate from the memory subsystem. Embodiments may be used in connection with a memory device having an actual memory size larger than its storage capability.

Embodiments of the present invention may be used to increase speed and/or reduce energy of writing data into a memory, or sending data through a transmission channel. As such, decreased time (and therefore cost) for programming memories may be realized. Due to reduced energy, battery lifetime of wireless devices incorporating data manipulation in accordance with embodiments of the present invention may be increased. Embodiments of the present invention may be particularly suited to storing large data in a memory subsystem including a stacked or embedded processor.

While the polarity of “0” and “1” data in a NOR flash memory is a matter of convention, it is to be understood that embodiments of the present invention may apply independently of that convention. For example, embodiments may be used in any storage or transmission technology having different speed and/or energy requirements for the two binary digits. Similarly, embodiments may be used in any storage or transmission technology with variable speed and energy requirements depending on a larger set of data values, such as two bits per cell multi-level cell technology for which programming speed and energy vary among four members of the data set: 11, 10, 01, 00.

Thus, in various embodiments data manipulation may be performed on data desired to be stored in a memory or transmitted via a transmission channel. Such manipulation may provide for faster writing to the memory and/or faster transmission, as well as reduced energy requirements for the same. In one particular embodiment, manipulations may be performed to provide more of the data in a state (e.g., logical one or zero) having a faster writing capability for a particular memory technology.

Embodiments of the present invention may be implemented in code and may be stored on a storage medium having stored thereon instructions which can be used to program a system, such as a wireless device to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), flash memories, electrically erasable programmable read-only memories (EEPROMs), magnetic or optical cards, or any type of media suitable for storing electronic instructions.

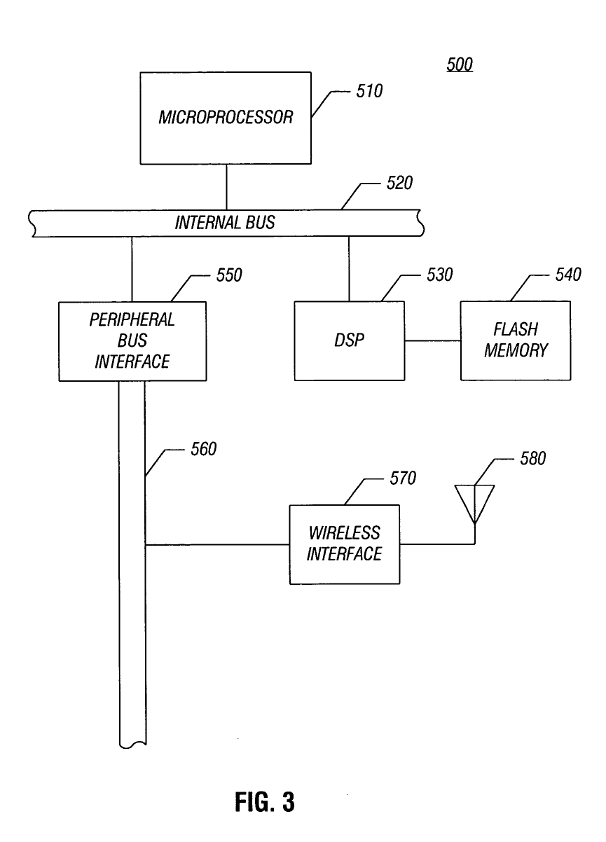

FIG. 3 is a block diagram of a wireless device with which embodiments of the invention may be used. As shown in FIG. 3, in one embodiment wireless device 500 includes a processor 510, which may include a general-purpose or special-purpose processor such as a microprocessor, microcontroller, application specific integrated circuit (ASIC), a programmable gate array (PGA), and the like. Processor 510 may be coupled to a digital signal processor (DSP) 530 via an internal bus 520. In turn, DSP 530 may be coupled to a flash memory 540 which may execute data manipulation in accordance with an embodiment of the present invention, and may also store the modified data image, in certain embodiments.

As shown in FIG. 3, microprocessor device 510 may also be coupled to a peripheral bus interface 550 and a peripheral bus 560. While many devices may be coupled to peripheral bus 560, shown in FIG. 3 is a wireless interface 570 which is in turn coupled to an antenna 580. In various embodiments antenna 580 may be a dipole antenna, helical antenna, or another such antenna.

Although the description makes reference to specific components of device 500, it is contemplated that numerous modifications and variations of the described and illustrated embodiments may be possible. More so, while FIG. 3 shows a block diagram of a wireless device, it is to be understood that embodiments of the present invention may be implemented in a system such as a personal computer, server, or the like. In such embodiments, a flash memory may be coupled to a Peripheral Component Interconnect (PCI) bus, as defined by the PCI Local Bus Specification, Production Version, Revision 2.1 dated in June 1995, or other such bus.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
manipulating a first data image into a modified data image, the modified data image having a faster write time than the first data image for a predetermined memory type.

2. The method of claim 1, further comprising storing the modified data image in a memory of the predetermined memory type.

3. The method of claim 1, wherein manipulating the first data image comprises performing a mathematical algorithm on the first data image.

4. The method of claim 3, further comprising selecting the mathematical algorithm based on a priori knowledge of at least one characteristic of the predetermined memory type.

5. The method of claim 1, wherein the modified data image is larger than the first data image.

6. The method of claim 1, further comprising transmitting the modified data image.

7. The method of claim 1, wherein the predetermined memory type has a different write speed for each of a set of data values.

8. The method of claim 1, wherein manipulating the first data image comprises biasing the modified data image to minimize occurrence of slow members of a data set to be stored in the predetermined memory type.

9. The method of claim 2, further comprising retrieving the modified data image from the memory and recreating the first data image therefrom.

10. A method comprising:
converting first data into modified data, the modified data having a reduced concentration of first bit states compared to the first data, wherein the first bit states have a greater energy consumption if written to a predetermined memory.

11. The method of claim 10, further comprising storing the modified data in the predetermined memory.

12. The method of claim 10, wherein converting the first data comprises performing a mathematical algorithm on the first data based on a priori knowledge of at least one characteristic of the predetermined memory.

13. The method of claim 10, wherein the predetermined memory comprises a NOR flash memory.

14. The method of claim 10, wherein the modified data is larger than the first data.

15. The method of claim 10, further comprising transmitting the modified data.

16. A system comprising:
at least one storage device to store code to manipulate a first data image into a modified data image, the modified data image having a faster write time than the first data image for a predetermined memory type; and
a dipole antenna coupled to the at least one storage device.

17. The system of claim 16, further comprising a stacked processor coupled to the at least one storage device to manipulate the first data image.

18. The system of claim 16, wherein the modified data image is stored in the at least one storage device.

19. An article comprising a machine-readable storage medium containing instructions that if executed enable a system to:
convert first data into modified data, the modified data having a reduced concentration of first bit states compared to the first data, wherein the first bit states have a slower write time for a predetermined memory.

20. The article of claim 19, further comprising instructions that if executed enable the system to store the modified data in the predetermined memory.

21. The article of claim 19, further comprising instructions that if executed enable the system to perform a mathematical algorithm on the first data based on a priori knowledge of at least one characteristic of the predetermined memory.

22. The article of claim 19, further comprising instructions that if executed enable the system to transmit the modified data.

23. A method comprising:
converting first data into modified data based on a priori knowledge of at least one characteristic of a transmission channel; and
transmitting the modified data via the transmission channel.

24. The method of claim 23, wherein the modified data has a reduced energy requirement for transmission in the transmission channel than the first data.

25. The method of claim 23, further comprising storing the modified data in a memory.

26. The method of claim 25, wherein the modified data has a faster write speed to the memory than the first data.

27. An apparatus comprising:
at least one storage device to store code to convert first data into modified data, the modified data having a reduced concentration of first bit states compared to the first data, wherein the first bit states have a greater energy consumption if written to a predetermined memory.

28. The apparatus of claim 27, further comprising a stacked processor coupled to the at least one storage device to convert the first data.

29. The apparatus of claim 27, wherein the predetermined memory comprises a flash memory.

30. The apparatus of claim 27, wherein the predetermined memory comprises a silicon-oxide-nitride-oxide-silicon memory.
